(19) United States
(12) Patent Application Publication
(10) Pub. No.: US 2009/0132939 A1
(43) Pub. Date: May 21, 2009

(54) METHOD AND APPARATUS FOR A FLOATING ISLAND FOR USER NAVIGATION IN AN INTERACTIVE ENVIRONMENT

(75) Inventors: David A. George, Somers, NY (US); Raymond R. Hitney, Buchanan, NY (US); Raymond B. Jennings, III, Ossining, NY (US); Malgorzata E. Stys, Purdys, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/942,544

(22) Filed: Nov. 19, 2007

(51) Int. Cl. G06F 3/048

(52) U.S. Cl. 715/763

(57) ABSTRACT

This invention provides a method for dynamically calculating and presenting a graphical user interface (GUI) within the display device in a computing system including a display device and an input device. The method includes creating a shared icon space within the GUI, automatically populating the shared icon space with GUI icons including stacking and clustering the GUI icons in the shared icon space based on current context, and potential user needs in view of the current user context and modifying the shared icon space in response to a detected change in current context.

### BACKGROUND OF THE INVENTION

The present invention relates to graphical user interfaces, and more particularly relates to a novel graphical user interface, method for navigating in an interactive environment utilizing the novel GUI and system that implements navigation in an interactive environment through the use of such a novel GUI with a floating island populated with GUI icons based on current user context.

Window-based graphical user interfaces, such as those available with Microsoft Windows (including CE), numerous UNIX implementations and those known to be used by/with Apple Computers include user-arrangeable screens and program launching means. But within such known graphical user interfaces, there is a marked lack of ability for adjusting the graphical user interface (GUI) to the users' current context in a dynamic and automatic manner.

FIG. 1 herein depicts a conventional prior art graphical user interface (GUI) display 101, the GUI display comprising a GUI display area 103. The GUI display area 103 is shown to include a set of GUI icons 102. GUI icons such as GUI icons 102 are usually associated with the invocation of new application instances that occupy all or part of the display area 103. For that matter, it is common that some applications allow only a single instance of an icon, the presentation of which being within the control of the application program providing the GUI. Each GUI icon of the set of GUI icons 102 is statically placed within the interface display 101 (display area 103) unless or until a current user moves them. That is, conventional GUIs 102 and their operation are not known to automatically adjust and modify GUI operation based on the current user context or state of use.

While GUI innovations have emerged that allow a user to proactively group GUI icons that have certain degrees or elements of association, such known GUI innovations lack the ability to dynamically and automatically adjust the icon layout, or icon visibility for the user within the GUI based on the present context. The present context of GUI 101 includes what application programs are currently active either in full, partial, or minimized view. As other application programs are launched, the other application program icons may block the view of a subset of icons 102 on the GUI display 101. On occasion, the user may find it cumbersome to locate a needed icon because it can be hidden by an application dialog. This would necessitate the adjustment of an application window to locate it.

Hence, there is a need in the art for a method and apparatus for dynamically and automatically creating and presenting in a GUI a set of GUI icons representative of the user's current context and operational state within the GUI.

### OBJECTS AND SUMMARY OF THE INVENTION

In one embodiment, the present invention comprises a graphical user interface that allows for user interface icons to be grouped within a floating island or window that automatically adjusts to the user, including icon population, based on the current context of the interface display (user current context). The floating island is automatically and dynamically populated with icons required to launch programs based on calculated anticipatory need of the current user, the anticipatory need based on the current context. The floating island is automatically positioned in an area of the display where it is easily visible and accessible to the current user. The invention can exploit other attributes of the floating island, including but not limited to its transparency (opacity) attribute, mouse-over behavior attribute, and size attribute to more readily facilitate the user's navigation in the interactive environment.

### BRIEF DESCRIPTION OF THE DRAWING FIGURES

The foregoing and other objects, aspects and advantages will be better understood from the following detailed description of embodiments of the inventions, with reference to the drawings, in which:

FIG. 1 is a screen shot of a conventional graphical user interface displaying user interface icons displayed (PRIOR ART);

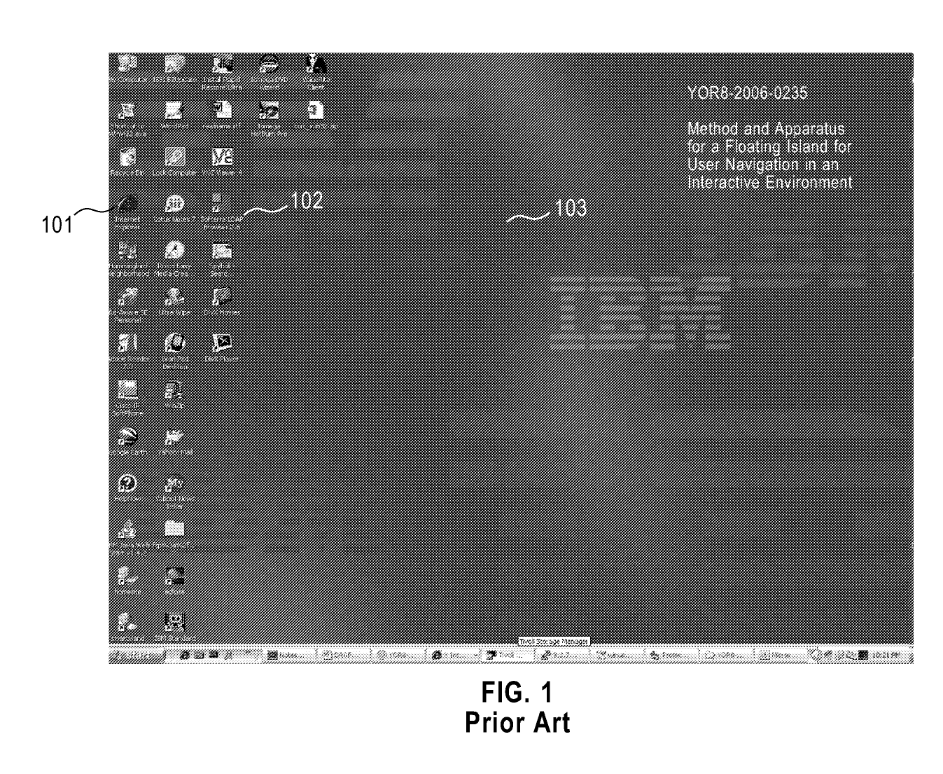

FIG. 2 is a screen shot of a graphical user interface displaying two “open” application windows, and a floating island including “mostly likely” candidate icons; and

FIG. 3 is a flowchart depicting one process of this invention; and

FIG. 4 is a representation of a general purpose computer into which has been provided a set of computer instructions for implementing the inventive method.

### DETAILED DESCRIPTION OF THE INVENTION

The inventive graphical user interface (GUI), computer system that implements the novel GUI and method for dynamically calculating and presenting the GUI with floating island of GUI icons is set forth and described herein for the purpose of conveying the broad inventive concepts. The drawings and descriptions provided are not meant to limit the scope and spirit of the invention in any way. To that end, reference will now be made in detail to the present invention, examples of which are illustrated in the accompanying drawings, wherein like reference numerals refer to like elements throughout. Although depicted as a Microsoft® Windows environment, this invention applies to any dialog environment, and should not be interpreted as being limited to implementation within an operating system interface.

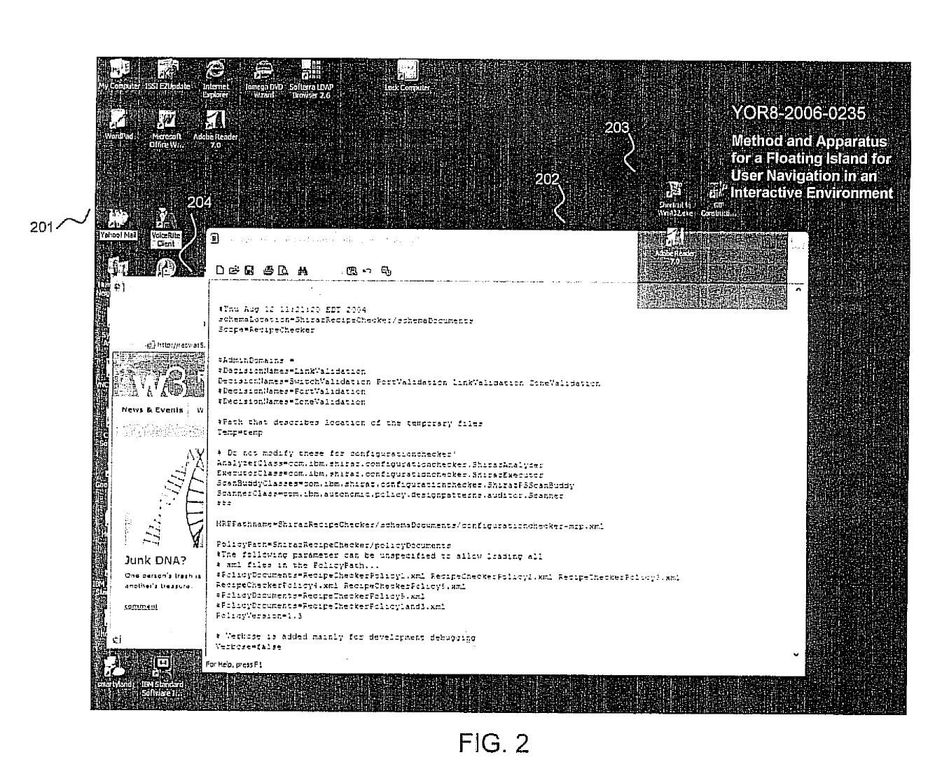

By operation of the novel method for dynamically calculating and presenting the GUI with floating island of GUI icons, the GUI is automatically populated with GUI icons within a shared icon space or floating island. The floating island is located in the GUI's total display area (or space). The GUI icons are populated in the floating island by stacking and clustering the GUI icons. FIG. 2 herein shows a GUI display 201 provided by the novel method, including open application dialog boxes 202, 204, and floating island 203, within which is displayed three (3) GUI icons. The three GUI icons are arranged in a grid-like, clustered manner as shown, but may be stacked to conserve space if needed under current use requirements.

During normal operation, the floating island 203 dynamically and automatically comes into view within the GUI display 201 depending upon its context, which context is defined by the currently active applications 202, 204. The floating island 203 is displayed anytime there is a recognized context, automatically by a background process or thread. In one example, where an application (for example, represented by the open dialog box 202) is a word processing application, the floating island of icons 203 might contain icons to launch other applications, such as a spreadsheet, graphics editor, calculator, database view or dictionary, etc.

The icons that populate the floating island 203 could be manually chosen by the user, or added dynamically based on context or use history. The history of a user interaction might show that a word processor application and a graphics editor are used concurrently by the user. In this case, if the occurrence count of active or opened application programs reaches a defined threshold, the graphics editor icon would be added to the island defined by this context. In some, cases it may be desirable to have one or more icons always contained within the floating island 203, such as for applications that are frequently and commonly used. Such operational parameters are readily adjustable by the user in accordance with the invention.

The floating island 203 can automatically move so that it is persisting in view, providing that no application window is in a fill screen state. For example, as application windows 202, 204 move within the interface screen 201, the floating island 203 automatically adjusts in size and shape to fit into some non-used viewing area of the interface display 201. If the available area for island 203 becomes smaller than the space needed to show all icons within the island, the icons can be stacked. Stacking the icons can be achieved by morphing them from one to another automatically over time, wherein the user waits for the desired icon to appear. Also, the icons can be presented in a combination chosen by manual user selection.

The floating island (203) should be understood to have just appeared as shown in FIG. 2. Hence, the FIG. 2 floating island as shown has not yet been suitably placed by the novel method within the GUI display 201. Proper placement of the floating island 203 (and clustered icons) includes that the clustered three icons are prominently located (displayed) within the display space of GUI display 201. The GUI icons may represent the currently running instance of application programs, if available. Hence, the presence of the GUI icons within the floating island, including the window state of the application program defines the current “context” of the GUI (201). Minimizing or terminating an application program ends or modifies the current context with respect to that application program, and a new context may then immediately be recognized if there is sufficient presence on the display, such as by a running application program indicated by dialog boxes 202, 204.

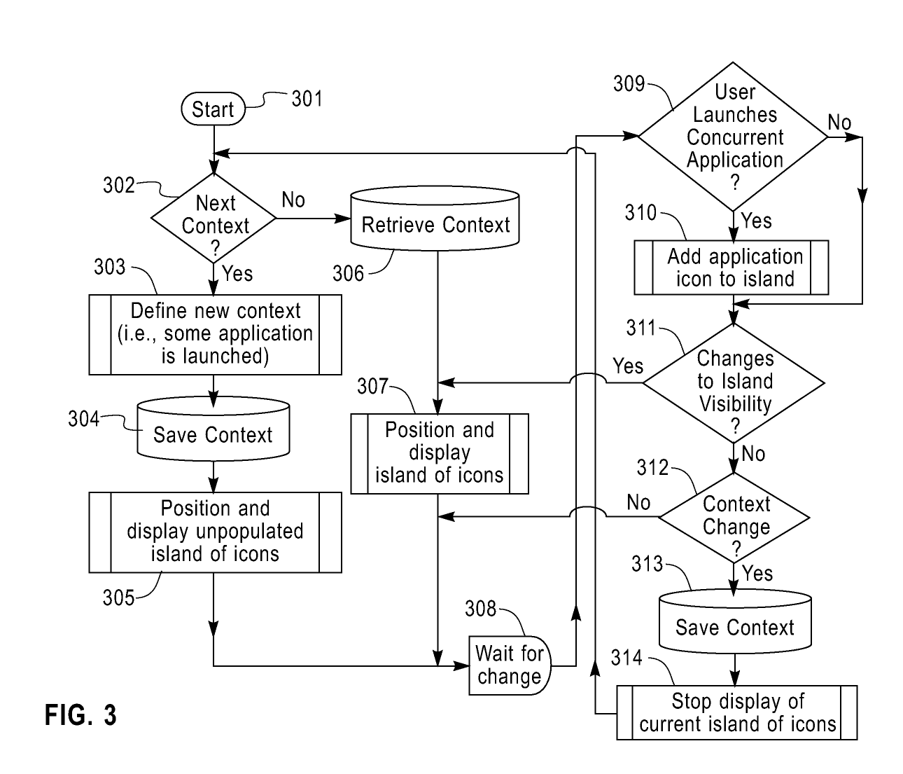

FIG. 3 is a process flow diagram highlighting the processing flow implemented by a novel method of the invention. A resident or underlying process (or thread) maintains the functionality of determining current context and controlling the presence of the associated floating island of GUI icons (such as 203 in FIG. 2). The root process (i.e., the method) may be launched or initiated by any known launch process via the novel graphical user interface. Functional block 301 represents the start of the process, and functional decision block or diamond 302 represents a step of determining whether the GUI or display screen complement includes or describes a new or prior context.

If there is no prior context, program flow moves to functional block 303, by which a new context is defined based on the application, or combination of applications currently running. The context is derived at least with respect to the running application programs. Functional block 304 represents a step where the context for the running application program, or programs, is saved in a context memory, or a specified context database. Context is saved even if the context memory is empty, and even if there are no application programs presently running. Functional block 305 represents a step of displaying the floating island. If there are no running application programs, there are no GUI icons to populate the floating island, but the floating island is displayed regardless of whether there are GUI icons to populate it based on current context. The processing flow then moves to functional block 308, representative of a step of waiting for a change of context.

If the decision step represented by functional decision block or diamond 302 finds that the GUI or display screen complement includes or describes a prior context, the program or process flow moves to block 306. Block 306 is representative of a step including retrieving the existing or prior context information. Block 307 represents a step that populates, positions and displays the floating island including the GUI icons based on the retrieved context (information), as described. The resident process then awaits changes that indicate potential changes to the context, as represented by functional block 308. When changes are detected, the resident process determines or calculates whether a current user has invoked another application, as represented by a functional block 309. If so, that application is added to the defined context, and icon is added to the floating island as shown and represented by functional block 310 in FIG. 3.

The program flow arrives at functional decision block 311 from block 309, either directly in a case where there is no determined new launches of an application program, or indirectly through functional block 310. Functional decision block or diamond 311 represents a decision step, where the novel method determines if the floating island's visibility is suitable. If re-arrangement is required (i.e., the visibility is unsuitable), the current island is repositioned in the step represented by functional block 307 (and described above). If re-arrangement is not necessary because the view is suitable, the process flow moves to a step in which context changes are determined, as represented by block 312 in the figure.

If the context remains unchanged as determined by the function represented by block 312, the processing flow suspends until some event occurs (the waiting indicated by block 308). If the context is determined to have changed based on an event occurrence, the current context is said to be no longer in force. Therefore, the current context is saved 313, but the application program's GUI icon is removed from the floating island view, as represented by functional block 314. The processing flow then continues back to the function represented by functional decision block or diamond 302, where again the underlying process or thread determines or attempts to determine what context is in effect.

While in the step represented by functional block 310, the icon can be added along with a reference count. It is only after the co-running application has reached the use threshold, definable by the user, that the added icon actually becomes visible on the GUI (in the floating island). The positioning and displaying of the floating island and GUI icons therein (as represented by functional blocks 305, 307) may comprise any known process or means available for implementing such positioning and displaying within the knowledge of the conventional arts.

Furthermore, the novel method or process of the invention does not require defining the detail of the user's ability to customize the contents of the context database, as represented by functional blocks 306 and 313 in the FIG. 3 method. Preferably, the novel method includes an extra processing feature for implementing an editing function that allows the user to customize a policy for implementing the process of functional block 303 in order to predefine contexts, and to modify the content of any predefined contexts. Such novel operation may be controlled by a rules engine, including implementing rules to forbid defining a context under certain circumstances, such as the occurrence of an instant message, an email notification, a calendar reminders or like functional occurrences.

The various method embodiments of the invention will be generally implemented by a computer executing a sequence of program instructions for carrying out the steps of the method, assuming all required data for processing is accessible to the computer. The sequence of program instructions may be embodied in a computer program product comprising media storing the program instructions. As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein. Alternatively, a specific use computer, containing specialized hardware for carrying out one or more of the functional tasks of the invention, could be utilized.

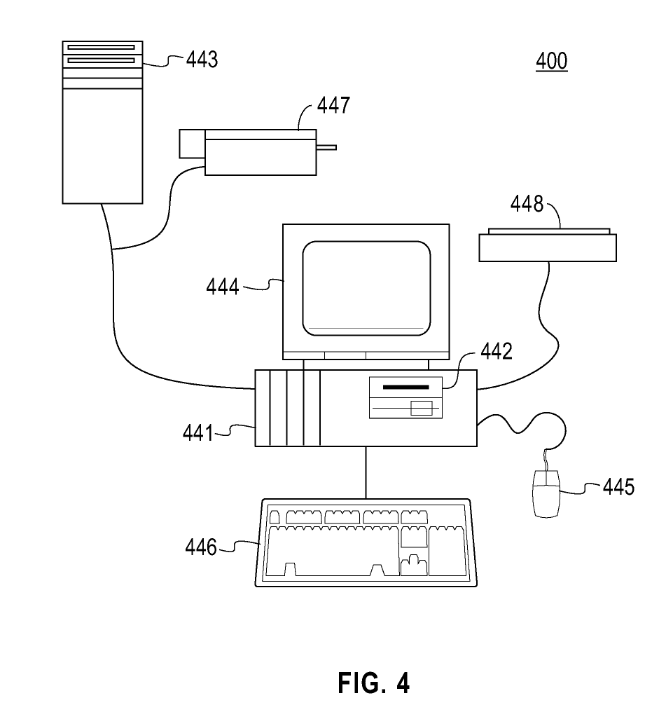

A computer-based system 400 is depicted in FIG. 4 herein by which the method of the present invention may be carried out. Computer system 400 includes a processing unit 441, which houses a processor, memory and other systems components that implement a general purpose processing system or computer that may execute a computer program product. The computer program product may comprise media, for example a compact storage medium such as a compact disc, which may be read by the processing unit 441 through a disc drive 442, or by any means known to the skilled artisan for providing the computer program product to the general purpose processing system for execution thereby.

The computer program product comprises all the respective features enabling the implementation of the methods described herein, and which—when loaded in a computer system—is able to carry out these methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 441 (as mentioned) or may be located on a remote system such as a server 443, coupled to processing unit 441, via a network interface such as an Ethernet interface. Monitor 444, mouse 445 and keyboard 446 are coupled to the processing unit 441, to provide user interaction. Scanner 447 and printer 448 are provided for document input and output. Printer 448 is shown coupled to the processing unit 441 via a network connection, but may be coupled directly to the processing unit. Scanner 447 is shown coupled to the processing unit 441 directly, but it should be understood that peripherals may be network coupled, or direct coupled without affecting the ability of the processing unit 441 to perform the method of the invention.

The method can include that the GUI icons populating the floating, shared icon space may be stacked and clustered. In addition, the method can include that the floating, shared icon space is characterized by icon attributes including at least transparency (opacity), mouse-over behavior, and size. The method can include that the GUI icons represent user-associated application programs, available user services and files anticipated as likely to be utilized by the current user based on the current user context. In such case, the current user context derives from data representative of which applications are presently active, a current display state, a time for which the active applications are running and whether the active applications are current user-launched. The method may also include that the step of automatically populating includes that the GUI icons displayed in the floating, shared icon space are related to both current and prior application program usage.

The method can include that the step of modifying the floating, shared icon space includes that the GUI icons are automatically added, deleted or modified based on the current user context. In such case, the steps of populating and modifying include that the GUI icons are chosen, added, deleted or modified by the user, and wherein the choosing, adding, deleting and modifying further qualify current user context. It follows that the GUI icons may be shown in view, in partial view, minimized, and/or maximized. For that matter, the the step of automatically populating may include that the GUI icons are displayed for a specified period of time within the icon space. Alternatively, the step of automatically populating includes that where only a limited number of icon spaces are available in the floating, shared icon space, and wherein a number of GUI icons required to be populated based on the current context exceeds the limited number, the floating, shared icon space may be shared between at least two GUI icons.

The method can also include that sharing of icon spaces includes fading (morphing) the GUI icons over a time, and allows the user to freeze the morphing and select a new GUI icon via standard user/GUI interaction. The invention includes a computer system, the system including a system processor, a display device in communication with the system processor and an input device. The computer system dynamically calculates and presents a graphical user interface (GUI) within a display of the display device based on current user context by implementing a method that includes creating a floating, shared icon space within the GUI, automatically populating the floating, shared icon space with GUI icons based on the current user context, and anticipated current user needs and modifying the floating, shared icon space in response to a detected change in current context.

Although a few examples of the present invention have been shown and described, it would be appreciated by those skilled in the art that changes may be made in these embodiments without departing from the principles and spirit of the invention, the scope of which is defined in the claims and their equivalents.

1. In a computing system including a display device and an input device, a method for dynamically calculating and presenting a graphical user interface (GUI) within the display device based on current user context, which comprises the steps of:
creating a floating, shared icon space for display within a current desktop viewing area presented via the GUI upon recognizing a current display context;
automatically populating the floating, shared icon space with GUI icons based on the current user context and anticipated current user needs, said anticipated user needs comprising a further application which that user has had prior interaction with in association with the current running application; and
modifying the floating, shared icon space in response to a detected change in current context, and anticipated current user needs and dynamically adding or deleting said icons representing said further application within said floating shared icon space based on said current user context and past user behavior; and, automatically adjusting the floating island in size and shape to enable persistent view within the GUI.

2. A computer program product, the computer program product comprising:
a tangible storage medium readable by a processing circuit and storing instructions for execution by the processing circuit for performing a method as set forth in claim 1.
